(19) United States
(12) Patent Application Publication
(10) Pub. No.: US 2018/0341435 A1
(43) Pub. Date: Nov. 29, 2018

(54) INFORMATION DISPLAY SYSTEM, INFORMATION PROCESSING TERMINAL, AND DISPLAY METHOD

(71) Applicant: Takejiroh Matsuyama, Ishikawa (JP)

(72) Inventor: Takejiroh Matsuyama, Ishikawa (JP)

(73) Assignee: Ricoh Company, Ltd., Tokyo (JP)

(21) Appl. No.: 15/973,924

(22) Filed: May 8, 2018

(30) Foreign Application Priority Data
May 23, 2017 (JP) 2017-101717

(51) Int. Cl. G06F 3/12; G06T 11/60

(52) U.S. Cl. CPC G06F 3/1204; G06F 3/1242; G06F 3/1292; G06F 3/1256; G06F 3/1288; G06T 11/60

(57) ABSTRACT

An information display system includes an image forming apparatus including circuitry to monitor whether an external device is mounted to the image forming apparatus, a server communicably connected to the image forming apparatus, the server including a memory to store AR data to be displayed in augmented reality corresponding to the image forming apparatus and includes at least data indicating a mounting position of the external device to the image forming apparatus, and an information processing terminal communicably connected to the image forming apparatus and the server.

### CROSS-REFERENCE TO RELATED APPLICATIONS

This patent application is based on and claims priority pursuant to 35 U.S.C. § 119(a) to Japanese Patent Application No. 2017-101717, filed on May 23, 2017 in the Japan Patent Office, the entire disclosure of which is hereby incorporated by reference herein.

### BACKGROUND

### Technical Field

Aspects of the present disclosure relate to an information display system, an information processing terminal, and a display method.

### Related Art

An electrophotographic image forming apparatus, such as a printer, a facsimile, a scanner, a copier, and a multifunction peripheral, forms a latent electrostatic image on a surface of a photoreceptor drum serving as an image bearer, develops the latent electrostatic image on the photoreceptor drum with a development agent such as toner to obtain a visual image, transfers the visual image to a recording medium, and fixes the toner image on the recording medium using a fixing device with pressure and heat.

Further, inkjet image forming apparatuses include a recording head comprised of a liquid discharge head to discharge ink droplets onto a recording medium while conveying the recording medium.

Various media, such as an SD card and a USB (Universal Serial Bus) memory, consumable supplies such as toner and paper, and cables, for example, are mounted on, loaded in, or connected (hereinafter collectively referred to as “mounting”) to the image forming apparatus. However, unlike a personal computer or the like, it may be difficult to mount such media, consumable supplies, cables, etc., on an exterior of the image forming apparatus.

### SUMMARY

In an aspect of the present disclosure, an information display system includes an image forming apparatus including circuitry to monitor whether an external device is mounted to the image forming apparatus, a server communicably connected to the image forming apparatus, the server including a memory to store AR data to be displayed in augmented reality corresponding to the image forming apparatus and includes at least data indicating a mounting position of the external device to the image forming apparatus, and an information processing terminal communicably connected to the image forming apparatus and the server. The information processing terminal includes circuitry to acquire the AR data of the image forming apparatus from the server, control the display to display the AR data, the AR data being superimposed on the captured image data, acquire mounting information indicating whether the external device is mounted to the image forming apparatus from the image forming apparatus, and control the display to display the mounting information, the mounting information being superimposed on the captured image data and the AR data.

In another aspect of the present disclosure, an information processing terminal includes an image capturing device to capture an image of an image forming apparatus communicably connected to the information processing terminal, an image data display to display image data of the image forming apparatus captured by the image capturing device, an AR data display to acquire AR data of the image forming apparatus from a server communicably connected to the image forming apparatus and the information processing terminal and to display the AR data by superimposing the AR data on the image data displayed on the image data display, and a mounting status display to acquire mounting information indicating whether an external device is mounted to the image forming apparatus from the image forming apparatus and to display the mounting information by superimposing the mounting information on the image data and the AR data displayed on the image data display.

In another aspect of the present disclosure, a display method includes displaying image data of an image forming apparatus captured by an image capturing device on a display controller of an information processing terminal, acquiring AR data of the image forming apparatus from a server communicably connected to the image forming apparatus and the information processing terminal, displaying the AR data by superimposing the AR data on the image data displayed on the display controller, acquiring mounting information indicating whether an external device is mounted to the image forming apparatus from the image forming apparatus, and displaying the mounting information by superimposing the mounting information on the image data and the AR data displayed on the display controller.

### BRIEF DESCRIPTION OF THE DRAWINGS

The aforementioned and other aspects, features, and advantages of the present disclosure will be better understood by reference to the following detailed description when considered in connection with the accompanying drawings, wherein:

FIG. 1 illustrates an example of a configuration of an information display system according to an embodiment of a present disclosure;

FIG. 2 is a block diagram of an example of a hardware configuration of an image forming apparatus;

FIG. 3 is a block diagram of an example of a hardware configuration of the model information storing server;

FIG. 4 is a block diagram of an example of a hardware configuration of the information processing terminal;

FIG. 5 is a block diagram of an example of a functional configuration of the image forming apparatus;

FIG. 6 is a block diagram of an example of a functional configuration of the model information storing server;

FIG. 7 is a block diagram of an example of a functional configuration of the information processing terminal;

FIG. 8 is a sequence diagram of an example of an AR data display process; and

FIG. 9 illustrates an example of an AR data display of the information processing terminal.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

In describing embodiments illustrated in the drawings, specific terminology is employed for the sake of clarity. However, the disclosure of this patent specification is not intended to be limited to the specific terminology so selected and it is to be understood that each specific element includes all technical equivalents that have the same function, operate in an analogous manner, and achieve similar results.

Although the embodiments are described with technical limitations with reference to the attached drawings, such description is not intended to limit the scope of the disclosure and all the components or elements described in the embodiments of this disclosure are not necessarily indispensable. As used herein, the singular forms “a”, “an”, and “the” are intended to include the plural forms as well, unless the context clearly indicates otherwise.

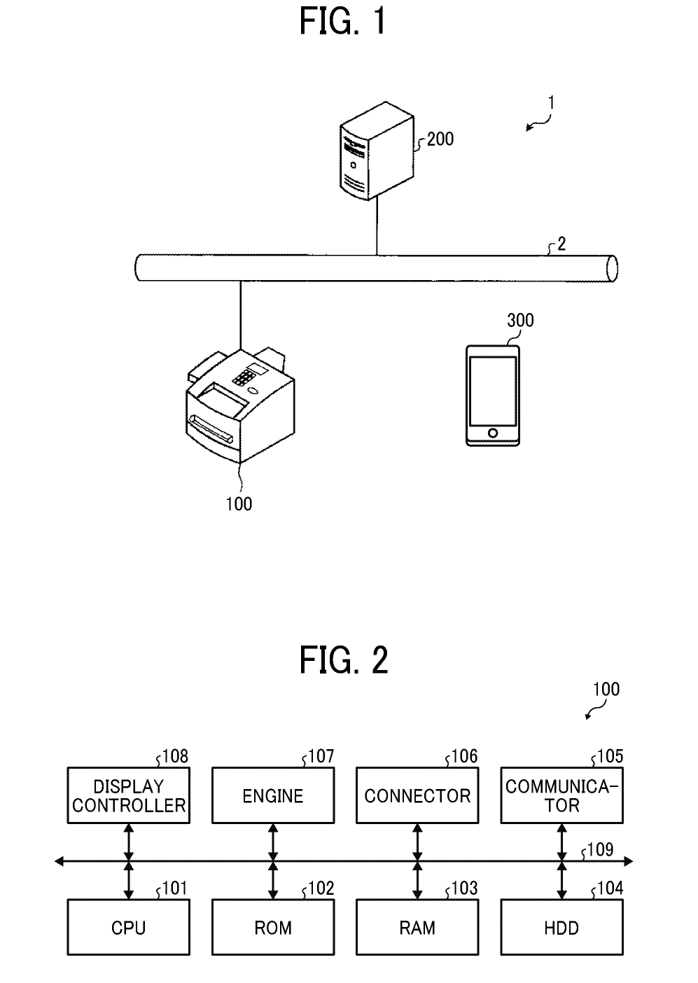

Configurations of embodiments according to the present disclosure are described below with reference to FIGS. 1 to 9. Hereinafter, media, consumable supplies, cables, and the like externally mountable to an image forming apparatus are collectively referred to as external devices.

In many cases, the connections (mounting positions) of the external device in the image forming apparatus (that is, a media slot, a terminal of a cable, and the like) are not collected in one place on the exterior of the image forming apparatus. This configuration makes it difficult to properly and quickly mount the external device to the image forming apparatus. Further, the mounting position of the external device is often different for each model of the image forming apparatus. In the case of using a plurality of image forming apparatuses, it further makes it difficult to properly and quickly mount the external device on the image forming apparatus.

Thus, it is difficult for the user to know where to mount and use the external device.

Even a removal of the external device is necessary after the external device is mounted to the image forming apparatus and used, the user is likely to forget to remove or collect the external device from the image forming apparatus. In this case, it is difficult to check the mounting status of the external device in the image forming apparatus. In order to visually check the scattered mounting positions of the external devices, the user actually has to move to and confirm the mounting position of the external device on the image forming apparatus. Further, it is necessary to confirm the mounting position of the external device while moving between multiple image forming apparatuses disposed at remote positions when a plurality of image forming apparatuses are used.

Further, the control panel generally simply displays a shortage of consumable supplies such as toner or an operation for replacing the supplies on the operation panel or the like in the image forming apparatus when the consumables are exhausted. Thus, it is difficult for the user who does not sufficiently know the configuration of the image forming apparatus to recognize where to replenish the supply just from a simple display of the image on the control panel of the image forming apparatus.

According to the present disclosure, an information display system 1 provides the mounting position and mounting information for an external device of the image forming apparatus as appropriate.

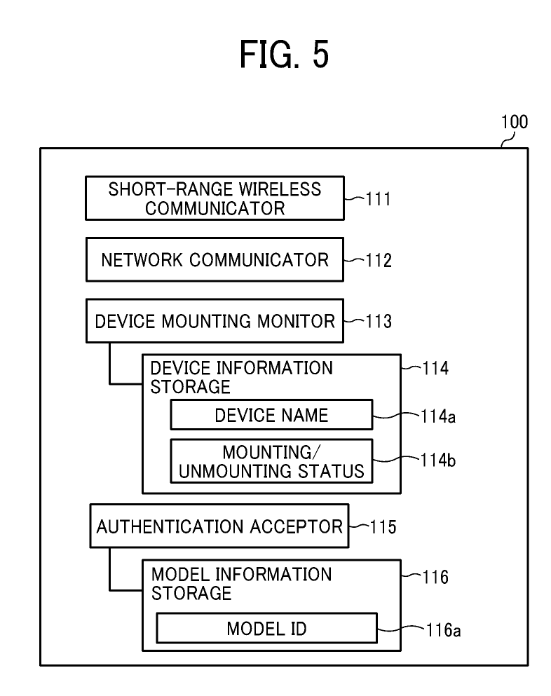

The information display system 1 according to the present embodiment includes an information processing terminal 300, a model information storing server 200 (server), and an image forming apparatus 100, communicably connected to each other. As illustrated in FIG. 5, the image forming apparatus 100 includes a device mounting monitor 113 (device monitor) to monitor whether or not the external device is mounted to the image forming apparatus 100.

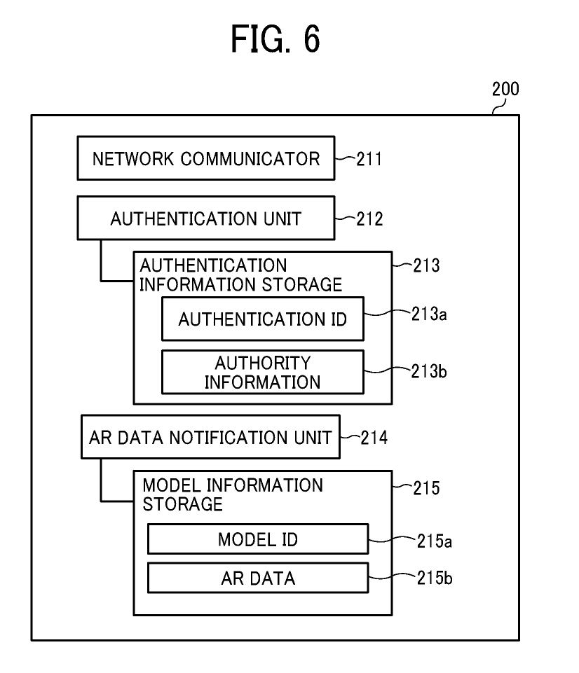

The external device is detachably attachable to the image forming apparatus 100. As illustrated in FIG. 6, the model information storing server 200 includes a model information storage 215 that stores augmented reality data (AR data 215b) displayed in augmented reality corresponding to the image forming apparatus 100. The AR data includes at least data indicating a mounting position of the external device to the image forming apparatus 100.

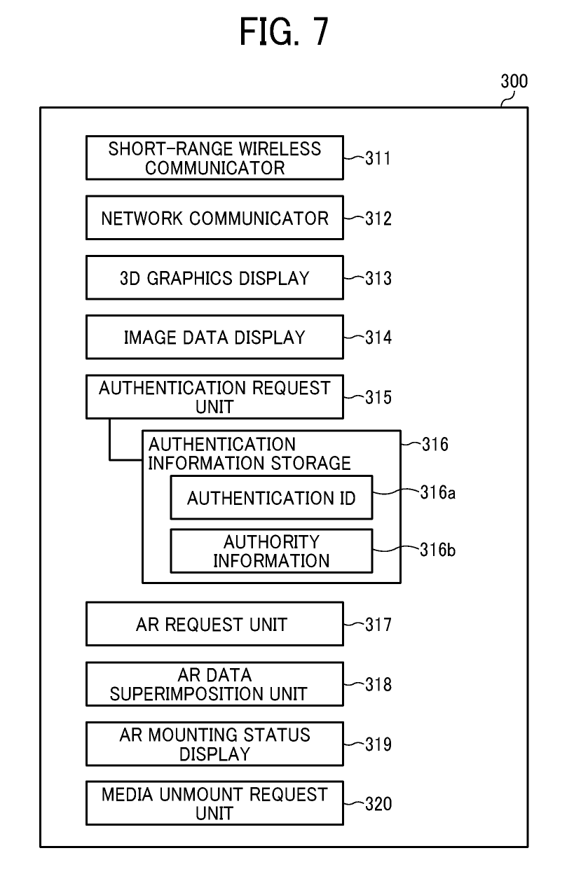

As illustrated in FIG. 7, the information processing terminal 300 includes an image data display 314, an AR data display (a 3D graphics display 313 and an AR data superimposition unit 318), and an AR mounting status display 319 (mounting status display). The image data display 314 displays captured image data of the image forming apparatus captured by an image capturing device 307 on a display controller 305 (display). The AR data display (the 3D graphics display 313 and an AR data superimposition unit 318) acquires the AR data of the image forming apparatus 100 from the model information storing server 200 and displays the AR data by superimposing the AR data on the image data displayed on the display controller 305. The AR mounting status display 319 acquires mounting information indicating whether or not the external device is mounted to the image forming apparatus 100 from the image forming apparatus 100 and displays the mounting information by superimposing the mounting information on the captured image data and AR data displayed on the display controller 305. The function of the AR data display and the AR mounting status display 319 may be implemented by circuitry such as CPU 301 in the image forming apparatus 100.

Here, the description in parentheses indicates reference numerals and application examples in the embodiments.

FIG. 1 illustrates an example of a configuration of an information processing system according to an embodiment of the present disclosure. The information display system 1 according to the present disclosure includes an image forming apparatus 100, the model information storing server 200, and the information processing terminal 300.

FIG. 1 illustrates only one of the image forming apparatus 100, the model information storing server 200, and the information processing terminal 300, respectively. However, the information display system 1 may include multiple image forming apparatuses 100 and information processing terminals 300. Further, although the model information storing server 200 may be generally composed of a single unit, the functions of the model information storing server 200 described below may be shared among a plurality of servers. For example, a dedicated server (authentication server) may be additionally provided, which only executes an authentication process.

In the information display system 1 of the present embodiment, the image forming apparatus 100 and the information processing terminal 300 are communicably connected by short-distance wireless communication such as Bluetooth (registered trademark), UWB (Ultra-Wide Band), ZigBee, and NFC (Near Field Communication), for example.

In the information display system 1, the image forming apparatus 100, the model information storing server 200, and the information processing terminal 300 are connected via a network 2 such as a wired or wireless LAN (Local Area Network) or the Internet. Thus, communication is established between the image forming apparatus 100 and the model information storing server 200 and between the model information storing server 200 and the information processing terminal 300 via the network 2.

The image forming apparatus 100 is a multifunction peripheral (MFP) that combines two or more of functions such as scanning, printing, copying, facsimile transmission and the like, in a single casing. Alternatively, a scanner having the function of scanning, a printer having the function of printing, a copier having the function of copying, or a facsimile having the function of facsimile transmission, or any combination thereof, may be used as the image forming apparatus 100.

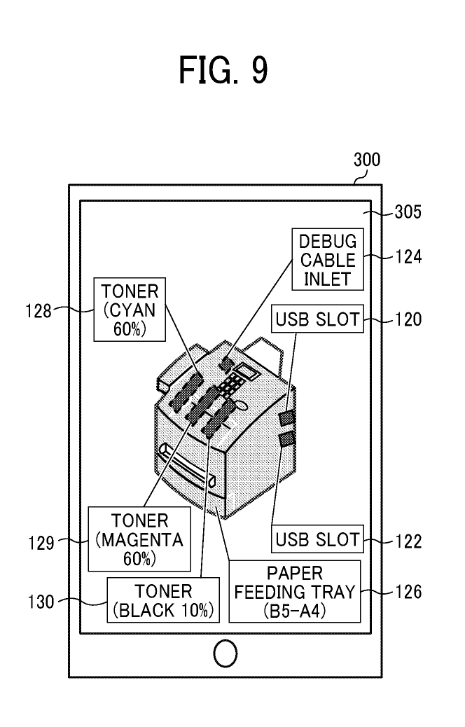

The image forming apparatus 100 has one or more media slots, such as an SD card slot 120 and a USB slot 122, and a plurality of terminals, such as a debug cable inlet 124, a serial cable terminal and a SATA cable terminal (see FIG. 9). Examples of an external device to be mounted to the image forming apparatus 100 include a device used also with a personal computer, such as an SD (Secure Digital) card, an MMC (Multimedia Card) card, an SDIO (Secure Digital Input/Output) device, a USB device, a debug serial cable, a SATA (Serial ATA) cable, a plug-and-play cable such as a LAN cable, and the like.

Further, a paper feeding tray 126 (see FIG. 9) and paper, toner, and a toner box (toner container), a waste toner box (waste toner collector), and the like can be listed as the external device dedicated to the image forming apparatus 100. At least one external device among the external devices described above is mountable to the image forming apparatus 100. Further, the image forming apparatus 100 can be modified such that detachable external devices may be added, changed, or deleted according to the user preference.

The model information storing server 200, implemented by a generic computer, includes a CPU (Central Processing Unit) and a memory.

The information processing terminal 300 is a terminal used by a user and accepting an operation from a user. The information processing terminal 300 is, for example, a mobile phone, a smartphone, a tablet PC, etc., and implemented by a computer that includes a CPU and a memory.

Hardware Configuration

Hereinafter, a hardware configuration of each device included in the information display system 1 is described.

(1) Image Forming Apparatus

FIG. 2 is a block diagram of an example of a hardware configuration of the image forming apparatus 100. The image forming apparatus 100 includes a CPU (Central Processing Unit) 101, a ROM (Read Only Memory) 102, a RAM (Random Access Memory) 103, a HDD (Hard Disk Drive) 104, a communicator 105, a connector 106, an engine 107, and a display controller 108. Each of the CPU 101, the ROM 102, the RAM 103, the HDD 104, the communicator 105, the connector 106, the engine 107, and the display controller 108 is connected to each other through a system bus 109.

The CPU 101 controls the entire operation of the image forming apparatus 100. The CPU 101 executes an operating system (OS) and various application programs stored in the ROM 102 or the HDD 104, etc., using the RAM 103 as a work area, to implement various functions such as a copy function, a scan function, a facsimile function, and a print function.

The HDD 104 further stores an image processing program for the image forming apparatus 100. The CPU 101 ensures security and allows the information processing terminal 300 to operate the image forming apparatus 100 by operating according to the information processing program for the image forming apparatus. The information processing program for the image forming apparatus 100 may be stored in the ROM 102 or the RAM 103.

The communicator 105, implemented by a communication circuit such as a Network Interface Card (NIC), enables the short-range wireless communication with the information processing terminal 300 and communication via the network 2 with the model information storing server 200.

The connector 106 includes ports connectable to media such as a USB memory and an SD card mounted to the image forming apparatus 100, slots to which cables and consumable supplies are mounted, and interfaces to control connected media and the like.

The engine 107 is hardware for performing general information processing and processing other than communication for achieving the copy function, the scanner function, the facsimile function, and the printer function. The engine 107 includes, for example, a scanner (image reader) that scans and reads an image of a document, a plotter (image forming device) that prints the image on sheet member such as a sheet of paper, and facsimile communication device that carries out facsimile communication. The engine 107 also may include specific optional devices, such as a finisher that sorts printed sheets and an automatic document feeding device (ADF) that automatically feeds a document.

The display controller 108 includes a liquid crystal display (LCD) or an organic electro-luminescence (EL) display including a touch panel controller. That is, the display controller 108 includes an input controller and a display controller, or any user interface device that interacts with the user. The display controlled by the display controller 108 in this example may be provided externally to the image forming apparatus 100.

(2) Model Information Storing Server

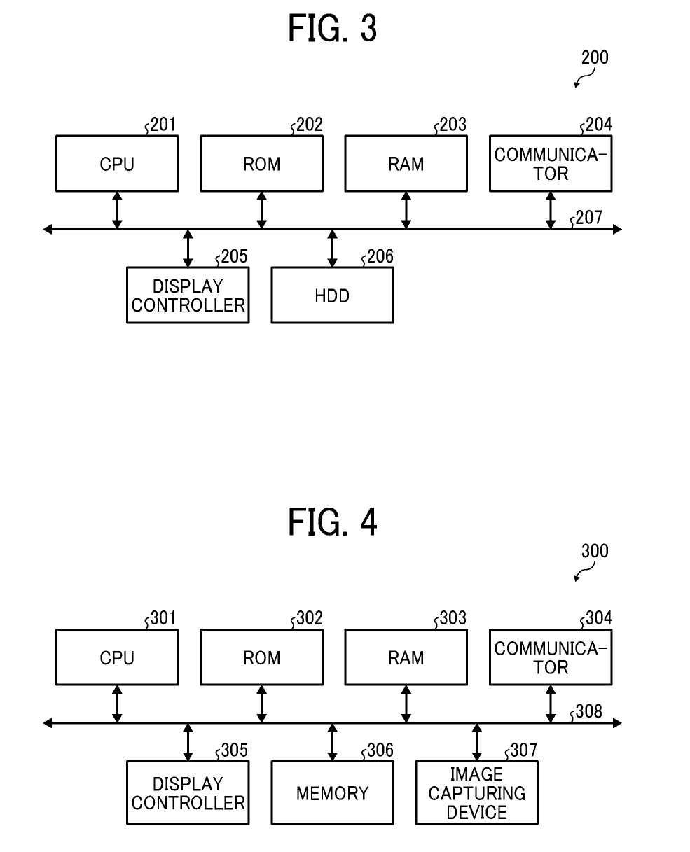

FIG. 3 is a block diagram of an example of a hardware configuration of the model information storing server 200. The model information storing server 200 includes a CPU 201, a ROM 202, a RAM 203, a communicator 204, a display controller 205, and an HDD 206. Each of the CPU 201, the ROM 202, the RAM 203, the communicator 204, the display controller 205, and the HDD 206 is connected to each other through a system bus 207.

The CPU 201 controls overall operation of the model information storing server 200. The CPU 201 executes the OS and various application programs stored in the ROM 202 or the HDD 206, while using the RAM 203 as a work area. The HDD 206 stores an image processing program for a server (the model information storing server 200), for example.

The CPU 201 operates accordance to the information processing program for the server and transmits information requested from the image forming apparatus 100 or the information processing terminal 300. Here, the information processing program for the server may be stored in the ROM 202 or the RAM 203. The communicator 204, implemented by a communication circuit such as a Network Interface Card (NIC), communicates with the image forming apparatus 100 via the network 2. As the display controller 205, a display, a keyboard, a mouse, and the like are provided, each of which is an example of a user interface device.

(3) Information Processing Terminal

FIG. 4 is a block diagram illustrating an example of a hardware configuration of the information processing terminal 300. The information processing terminal 300 includes a CPU 301, a ROM 302, a RAM 303, a communicator 304, a display controller 305, a memory 306, and an image capturing device 307. Each of the CPU 301, the ROM 302, the RAM 303, the communicator 304, the display controller 205, the memory 306, and the image capturing device 307 is connected to each other through a system bus 308.

The CPU 301 controls overall operation of the information processing terminal 300. The CPU 301 executes the OS and various application programs stored in the ROM 302 or the memory 306, for example, while using the RAM 303 as a work area. The memory 306 includes a semiconductor memory that stores an information processing program for the information processing terminal 300.

The CPU 301 operates in accordance with the information processing program for the information processing terminal 300 and performs each process such as an authentication request and a request for mounting information described below to the image forming apparatus 100 and the model information storing server 200. Further, the ROM 302 or RAM 303 may store the information processing program for the information processing terminal 300. The communicator 304, implemented by a communication circuit such as a Network Interface Card (NIC). The communicator 304 performs the short-range wireless communication with the image forming apparatus 100 and wireless communication such as Internet communication with the model information storing server 200.

The display controller 305 (display) includes a liquid crystal display (LCD) or an organic electro-luminescence (EL) display including a touch panel controller. Thus, the display controller 305 includes an input control function and a display function. The user inputs, for example, an operation command and a transfer request of desired data by operating the display controller 305.

The image capturing device 307 is a camera for imaging a subject. The user uses the image capturing device 307 to photograph the image forming apparatus 100 in the information display system 1.

Each of the information processing programs for the image forming apparatus 100, the model information storing server 200, and the information processing terminal 300 as described above is a file in a format installable or executable by the generic computer. The information processing programs may be recorded in a recording medium readable by a computer such as a CD-ROM, a flexible disk (FD), etc. Further, each information processing program may be recorded in a recording medium readable by a computer such as CD-R, DVD, Blu-ray Disc (registered trademark), semiconductor memory or the like and provided to the user. Further, each information processing program may be provided via a network such as the Internet. Further, each information processing programs may be provided by being implemented in a device such as a ROM in advance.

Functional Configuration

Hereinafter, a functional configuration of each device included in the information display system 1 is described.

FIG. 5 is a block diagram illustrating an example of a functional configuration of the image forming apparatus 100. The image forming apparatus 100 includes a short-range wireless communicator 111, a network communicator 112, a device mounting monitor 113, a device information storage 114, an authentication acceptor 115, and a model ID information storage 116.

FIG. 6 is a block diagram of an example of a functional configuration of the model information storing server 200. The model information storing server 200 includes a network communicator 211, an authentication unit 212, an authentication information storage 213, an AR data notification unit 214, and a model information storage 215.

FIG. 7 is a block diagram illustrating an example of a functional configuration of the information processing terminal 300. The information processing terminal 300 includes a short-range wireless communicator 311, a network communicator 312, a 3D graphics display 313, an image data display 314, an authentication request unit 315, an authentication information storage 316, an AR request unit 317, an AR data superimposition unit 318, an AR mounting status display 319, and a media unmount request unit 320.

(1) Image Forming Apparatus

The short-range wireless communicator 111 communicates with other devices physically located at short distances. In the information display system 1, the short-range wireless communicator 111 is used for a communication between the image forming apparatus 100 and the information processing terminal 300 located in a range communicably connected to the image forming apparatus 100. There is no particular limitation for the communication method on the short-range wireless communication, as long as the communication method uses a known communication method such as Bluetooth, UWB, ZigBee, NFC, or a new communication method.

The network communicator 112 performs communication by TCP/IP or Ethernet via the network 2. The information display system 1 communicates with the model information storing server 200 via the network 2.

The device mounting monitor 113 periodically monitors a mounting status of all the external devices mounted on the image forming apparatus 100. The device mounting monitor 113 detects the mounting status for each external devices and stores information of the mounting status in the device information storage 114. The function of the device mounting monitor 113 is implemented by circuitry such as CPU 101 in the image forming apparatus 100.

An example of monitoring the mounting status of the SD card is described below. The SD card becomes usable by inserting the SD card into the SD card slot 120 (see FIG. 9) of the connector 106 of the image forming apparatus 100. The device mounting monitor 113 can monitor mounting or unmounting of the SD card to the image forming apparatus 100 by detecting switching on or switching off of the physical switch provided in the SD card slot 120 of the connector 106. The physical switch turns on when the SD card is inserted into the SD card slot 120 of the connector 106. The physical switch turns off when the SD card is not inserted into the SD card slot 120 of the connector 106. Further, the device mounting monitor 113 monitors whether a control process of start using the external device (mounting process) at time of mounting has been normally completed and whether the external device is usable as a software. Thus, the device mounting monitor 113 monitors whether the external device is usable.

Information for each of the external devices is stored in the device information storage 114. The information stored in the device information storage 114 includes information having two elements, for example, a device name 114a and a mounting/unmounting status 114b. Either a status of mounting or unmounting is set as the mounting/unmounting status 114b according to a monitoring result of the device mounting monitor 113. For the external devices that require mounting process, information of whether the mounting process has been completed is also set as the mounting/unmounting status 114b. A number of information stored in the device information storage 114 corresponds to a number of external devices (the number of mounting positions of the external devices) on which the mounting status is monitored by the device mounting monitor 113.

Further, the device mounting monitor 113 responds to the information processing terminal 300 by transmitting the information stored in the device information storage 114 to the information processing terminal 300 as mounting information when the information processing terminal 300 requests the mounting information of a predetermined external device.

The authentication acceptor 115 receives an authentication request from the authentication request unit 315 of the information processing terminal 300 by short-range wireless communication. Further, the authentication acceptor 115 queries the model information storing server 200 whether an operation from the information processing terminal 300 (that is, the user of the information processing terminal 300) can be accepted.

When the response from the authentication unit 212 of the model information storing server 200 indicates “authenticated”, the authentication acceptor 115 notifies the information processing terminal 300 that the information processing terminal 300 is “communicable” with the image forming apparatus 100 in response to the authentication request from the information processing terminal 300. Then, the information processing terminal 300 starts an AR data display process. For example, a certificate of “communicable” is notified as the AR data display process. Conversely, if the response from the model information storing server 200 is “not authenticated”, the authentication acceptor 115 notifies the information processing terminal 300 that the information processing terminal 300 is “not communicable” with the image forming apparatus 100 in response to the authentication request from the information processing terminal 300. Thus, the information processing terminal 300 does not execute the AR data display process. Here, an authentication method to be used is not particularly limited, and any authentication methods, publicly known method or new method, can be used.

Thus, the information processing terminal 300 includes an authentication request unit 315 to request an authentication to the image forming apparatus 100 of an image capturing target. The server (model information storing server 200) includes an authentication unit 212 to determine whether the information processing terminal 300 is allowed for use in the information display system 1. The image forming apparatus 100 includes a relay device (network communicator 112) to relay an authentication between the information processing terminal 300 and the server (model information storing server 200).

The model ID information storage 116 stores model ID information 116a that is an ID unique to each image forming apparatus 100 and enables identification of the image forming apparatus 100. The model ID information 116a is not particularly limited to this example such that any type of information may be used. The model ID 116a may be represented by a numerical value of 32 bits, for example. At this time, the model ID information 116a may include an optional configuration such that the first half of 16 bits represents the model, and the second half of 16 bits represents the optional configuration.

(2) Model Information Storing Server

The network communicator 211 performs communication by TCP/IP or Ethernet via the network 2. In the information display system 1, the model information storing server 200 communicates with the image forming apparatus 100 and the information processing terminal 300 via the network 2.

The authentication unit 212 receives an inquiry from the authentication acceptor 115 of the image forming apparatus 100 and performs authentication. The authentication information storage 213 stores information used by the authentication unit 212 for authentication. For example, an authentication ID 213a and authority information 213b are stored in the authentication information storage 213.

Upon receiving the authentication request, the authentication unit 212 refers to the authentication ID and authenticates the information processing terminal 300 based on a match between two authentication IDs. These authentication IDs include an authentication ID 213a of the model information storing server 200 and the authentication ID 316a of the information processing terminal 300. Note that the authentication method used by the authentication unit 212 is not particularly limited to the above-described method. Since the information necessary for the authentication is different according to the authentication method, the information stored in the authentication information storage 213 is not limited to the information described above.

The authority information 213b is information indicating a type of a user such as a service engineer, a developer, an evaluator, a user, and the like. The AR data notification unit 214 refers to the authority information 213b when returning the AR data, and sends the AR data to the information processing terminal 300 according to the type of the user (authority).

The AR data notification unit 214 sends the AR data to the information processing terminal 300 according to the authority in response to the request from the information processing terminal 300. Thus, the model information storing server 200 receives the authentication information (authentication ID 316a and authority information 316b) from the information processing terminal 300 and the model ID 116a from the image forming apparatus 100. The model information storing server 200 searches the model information storage 215 for the AR data 215b corresponding to the authority based on the received authentication information and sends the searched AR data 215b to the information processing terminal 300.

The model information storage 215 stores model information read by the AR data notification unit 214. The model information is uniquely determined data determined by the model ID information 116a and the authority information 316b. The model information includes AR data 215b corresponding to each type of authority for each model ID 215a.

The AR data 215b is 3D data for AR display (also referred to as AR 3D data). The AR 3D data includes data for highlighting the mounting position of the external device together with the 3D data of the image forming apparatus 100. For example, the mounting position of the external device is displayed in a predetermined color (red, for example) and is highlighted. The AR data 215b also includes information for matching the imaged data captured by the image capturing device 307 of the information processing terminal 300 with 3D data for AR display.

(3) Information Processing Terminal

The short-range wireless communicator 311 communicates with other devices physically located at short distances. In the information display system 1, the short-range wireless communicator 111 is used for a communication between the information processing terminal 300 and the image forming apparatus 100 located in a range communicable with the information processing terminal 300 that is determined by a specification of the short-range wireless communicator 111.

The network communicator 312 performs communication by TCP/IP or Ethernet via the network 2. The information display system 1 communicates with the model information storing server 200 via the network 2.

The 3D graphics display 313 displays the 3D graphics object on the display controller 305. The information display system 1 displays the AR 3D data received from the model information storing server 200.

The image data display 314 controls the image capturing device 307 to take an image and displays the captured imaged data (picture or video) on the display controller 305. The information display system 1 displays the imaged data of the image forming apparatus 100 on the display controller 305.

The authentication request unit 315 requests authentication of the image forming apparatus 100 by short-range wireless communication using the authentication information stored in the authentication information storage 316. In case when the short-range wireless communication is not available, a QR code (registered trademark) readable by the information processing terminal 300 is attached in the vicinity of the control panel of the image forming apparatus 100 or the like, for example. The QR code is detected by the image capturing device 307 to acquire the model information of the image forming apparatus 100. Then, the authentication process is started between the model information storing server 200 and the image forming apparatus 100. Thus, even if the image forming apparatus 100 is not communicable due to power off, for example, authentication process can be performed.

The authentication request unit 315 stores the authentication information used for an authentication process in the authentication information storage 316. The authentication ID 316a and the authority information 316b are stored as the authentication information in the authentication information storage 316. The authentication ID 316a and the authority information 316b stored in the authentication information storage 316 respectively match the authentication ID 213a and the authority information 213b of the authentication information stored in the authentication information storage 213 of the model information storing server 200.

Then, as described above, the two authentication IDs (the authentication ID 213a and the authentication ID 316a) are verified (matched) via the image forming apparatus 100. Then, the authentication is permitted when the two authentication IDs match with each other. Note that the authentication method used by the authentication unit 212 is not particularly limited to any methods. Since the information necessary for the authentication is different according to the authentication method, the information stored in the authentication information storage 213 is not limited to the information described above.

When authentication is permitted, the authentication request unit 315 requests the image forming apparatus 100 for the model information. Then, the image forming apparatus 100 returns the model ID information 116a to the authentication request unit 315 in response to the request from the information processing terminal 300.

The authority information 316b is the authority information of the user of the information processing terminal 300. For example, the authority information 316b indicates a type of user such as a service person, a developer, an evaluator, a user, for example. The model information storing server 200 refers to the authority information 316b when the AR data 215b is returned to the information processing terminal 300 by the AR data notification unit 214 of the model information storing server 200. Then, the model information storing server 200 sends the AR data 215b corresponding to the type (authority) of the user to the information processing terminal 300.

When the authentication is permitted, the AR request unit 317 requests the AR data to the model information storing server 200. That is, the AR request unit 317 transmits the authentication information (authentication ID 316a and authority information 316b) and model ID information 116a of the image forming apparatus 100 to the AR data notification unit 214 of the model information storing server 200 to request for the AR data. In response to the request for the AR data from the AR request unit 317, the model information storing server 200 returns to the information processing terminal 300 the AR data 215b according to the authority and of the model of the corresponding image forming apparatus 100.

The AR data 215b sent from the model information storing server 200 according to the authority is highlighted. For example, only the mounting positions of the external devices that are permitted to be used according to the authority among the mounting positions of all the external devices of the image forming apparatus 100 are highlighted. For example, all terminals, media slots, etc. are highlighted in case the authority is the developer. However, only predetermined slots (SD card slot 120, USB slot 122, etc.) may be highlighted in case the authority is the user.

The AR data superimposition unit 318 superimposes the image data with the AR 3D data and displays the superimposed data on the display controller 305. The image data of the image forming apparatus 100 is captured by the image capturing device 307 and is displayed on the display controller 305. The AR 3D data is displayed on the display controller 305 by the 3D graphics display 313.

Further, the AR mounting status display 319 displays the mounting status (mounting information) of each external device acquired by requesting the image forming apparatus 100, in addition to the information displayed on the display controller 305 by the AR data superimposition unit 318. For example, taking the SD card slot 120 as an example, an image of the SD card slot 120 in an unmounting status (not mounting on the image forming apparatus 100) is displayed in a predetermined color (for example, blue).

Further, an image of the SD card slot 120 in a mounting status (mounting on the image forming apparatus 100) is displayed in another predetermined color (for example, red). Further, the mounting status of the SD card may be classified into three statuses of uninstalled, installed (unmounting), and installed (mounting) when the media is the SD card etc. that requires a system of the image forming apparatus 100 to perform a mounting process. In the uninstalled status, the SD card is not inserted into the SD card slot 120. In the installed (unmounting) status, although the SD card is inserted into the SD card slot 120, the system does not detect the SD card. In the installed (mounting) status, the SD card is inserted into the SD card slot 120, and the system detects the SD card. Further, each of the mounting statuses (uninstalled, installed (unmounting), and installed (mounting)) is preferably displayed with different colors.

Thus, the information display system 1 includes an image forming apparatus 100 including a device monitor (device mounting monitor 113) to monitor whether or not an external device (external device) is mounted to the image forming apparatus 100, a server (model information storing server 200) communicably connected to the image forming apparatus 100, the server (model information storing server 200) including a model information storage 215 to store AR data to be displayed in augmented reality, which corresponds to the image forming apparatus 100 and includes at least data indicating a mounting position of the external device to the image forming apparatus 100, and an information processing terminal 300 communicably connected to the image forming apparatus 100 and the server (model information storing server 200).

The information processing terminal 300 includes an image data display 314 to display image data of the image forming apparatus 100 captured by an image capturing device 307 on a display controller 305, an AR data display to acquire the AR data of the image forming apparatus 100 from the server (model information storing server 200) and to display the AR data by superimposing the AR data on the image data displayed on the display controller 305, and an AR mounting status display 319 (mounting status display) to acquire mounting information indicating whether or not the external device is mounted to the image forming apparatus 100 from the image forming apparatus 100 and to display the mounting information by superimposing the mounting information on the image data and the AR data displayed on the display controller 305.

The media unmount request unit 320 requests the image forming apparatus 100 to change the mounting status of a medium to the installed (mounting) status when a slot in the mounting status is displayed on a screen displayed on the display controller 305 by the AR mounting status display 319 and when it is detected that there is a predetermined operation (touch) on the screen by the user. It is preferable to allow a request to change the mounting status of the media from the installed (unmounting) status to the installed (mounting) status.

Thus, the information processing terminal includes a request unit (media unmount request unit 320) that requests the image forming apparatus 100 to change a status of the external device (external device) in the usable status to an unusable status and change a status of the external device in the unusable status to the usable status. The device monitor (device mounting monitor 113) of the image forming apparatus 100 controls to change the status of the external device (external device) according to the request from the request unit (media unmount request unit 320).

For example, when the user touches a medium in the installed (mounting) status, the media unmount request unit 320 issues a request to the target image forming apparatus 100 connected by the short-range wireless communication. The device mounting monitor 113 of the image forming apparatus 100 executes an unmounting process of the corresponding medium and controls to change the mounting status to the installed (unmounting) status. Then, the device mounting monitor 113 notifies a change of the mounting status of the medium to the information processing terminal 300. In this manner, the present embodiment enables to request unmounting of the media of the image forming apparatus 100. Thus, it is possible to safely detach the media from the image forming apparatus 100 to improve convenience.

AR Data Display Processing

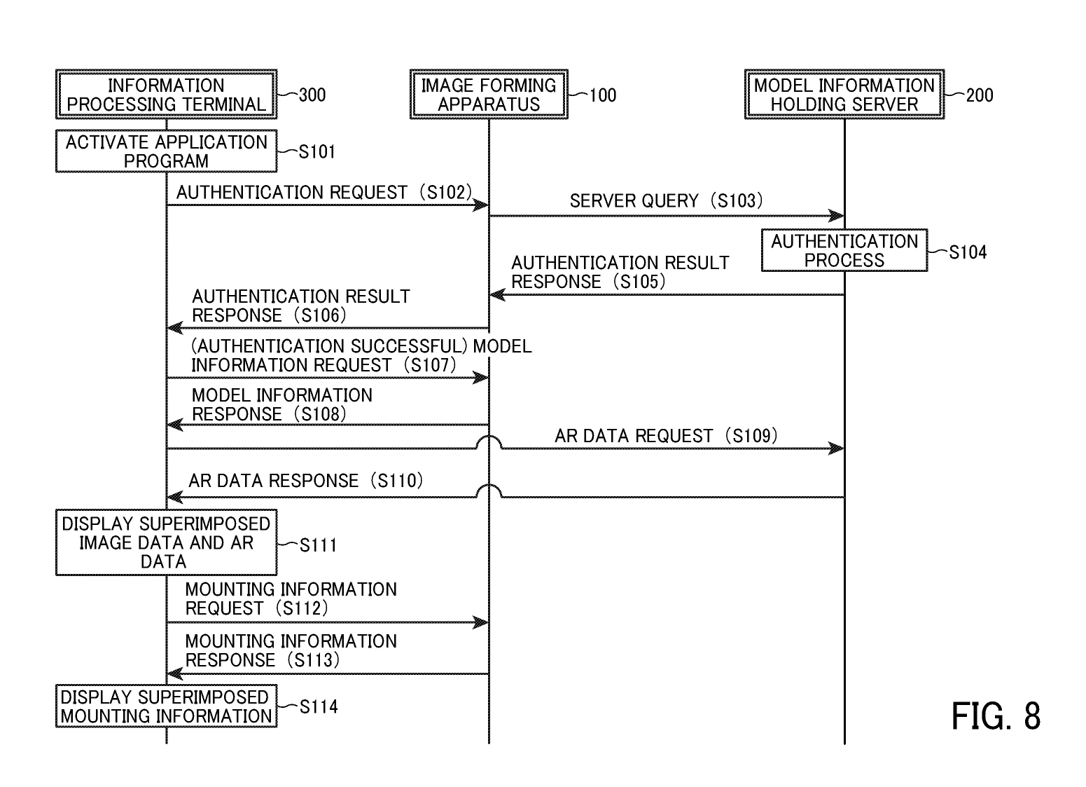

FIG. 8 is a sequence diagram of AR data display process executed by the information display system 1 according to the present embodiment.

First, the information processing terminal 300 activates an application program (information processing program for information processing terminal) that executes AR data display process (S101).

Next, an authentication process for the information processing terminal 300 is executed. That is, the authentication request unit 315 requests authentication to the image forming apparatus 100 with the short-range wireless communication using the authentication information stored in the authentication information storage 316 (authentication request, S102). In this system, the authentication information of a plurality of information processing terminals including the information processing terminal 300 is previously stored in the model information storing server 200.

Thus, the image forming apparatus 100 queries the model information storing server 200 whether the authentication information from the corresponding information processing terminal 300 is acceptable (server query, S103). After executing the authentication process (S104), the model information storing server 200 responds to the image forming apparatus 100 with the authentication result (authentication result response, S105 to S106). Note that the information processing terminal 300 may directly request authentication to the model information storing server 200.

When the authentication fails, the AR data display process is terminated. If authentication is successful, the information processing terminal 300 requests the image forming apparatus 100 for model information (model information request, S107). In the processes following after the step S107, the information transmitted from the information processing terminal 300 may include information that indicates that the authentication of the information processing terminal 300 is successful.

Upon receiving the model information request, the image forming apparatus 100 transmits the model ID 116a of the image forming apparatus 100 to the information processing terminal 300 (model information response, S108).

After receiving the model information of the image forming apparatus 100, the information processing terminal 300 sends an AR data request to the model information storing server 200. In the AR data request, the information processing terminal 300 transmits the authentication information and the model ID 116a of the image forming apparatus 100 to the model information storing server 200 (AR data request, S109). The model information storing server 200 returns the AR data on the model of the corresponding image forming apparatus 100 according to the authority of the user to the information processing terminal 300 (AR data response, S110).

Upon receiving the AR data from the model information storing server 200, the information processing terminal 300 starts displaying the AR data on the screen to the user. That is, the image data of the image forming apparatus 100 captured by the image capturing device 307 is displayed on the display controller 305. Further, 3D graphics data of the corresponding model included in the AR data is adjusted and displayed on the display controller 305 by rotating, enlarging, and reducing the 3D graphics data and further superimposed on the image of the image forming apparatus 100 (display superimposed image data and AR data, S111).

Thus, the display controller 305 of the information processing terminal 300 displays in augural reality (AR) the mounting position of the external device such that the mounting position is emphasized on the image data of the image forming apparatus 100 captured by the image capturing device 307, that is, the image data of the image forming apparatus 100 to which the user has directed the camera of the smartphone. Thus, the mounting position of the external device can be visually confirmed on the display controller 305.

After the mounting position of the external device is displayed on the display controller 305 of the information processing terminal 300, the information processing terminal 300 transmits to the image forming apparatus 100 to request the mounting information regarding a terminal, a slot, and the like that require the mounting information (mounting information request, S112).

In the image forming apparatus 100, the mounting statuses of the terminal and the media slot are periodically monitored by the device mounting monitor 113. Thus, the image forming apparatus 100 refers to the device information storage 114 to read the mounting information about the mounting position of the external device as requested. Then, the image forming apparatus 100 responds to the information processing terminal 300 with the mounting information such as uninstalled, installed (unmounting), installed (mounting) as described above (mounting information response, S113).

After receiving the mounting information, the information processing terminal 300 displays the mounting information on the display controller 305 together with the mounting position of the AR display being displayed (display superimposed mounting information, S114).

Thus, the user can visually confirm the mounting position of the external device and the mounting information of the external device with respect to the image forming apparatus 100 being imaged by the information processing terminal 300.

It is also preferable to display not only the mounting status but also the difference of contents of the media to be recognizable during the display process of the mounting status (S114). For example, in case the mounting status is displayed by a difference in color (blue, red, etc.), the contents of the media are displayed in alphabet. If two SD cards of different contents are inserted into two slots, respectively, the display controller 305 displays the two SD cards distinguishably such as a SD card A and a SD card B, etc. Thus, even when a plurality of external devices of the same type is mounted on the image forming apparatus 100, the mounting position and the mounting information of the external devices can be distinguishably displayed on the display controller 305.

When there is a plurality of image forming apparatuses 100 in the field angle of the image capturing device 307 and the plurality of image forming apparatuses 100 are within communicable range, the processes described above are executed concurrently for the plurality of image forming apparatuses 100. Thus, the display controller 305 can simultaneously display in augmented reality (AR) the mounting statuses and the mounting positions of the external devices mounted on the plurality of image forming apparatuses 100.

Further, the AR data display process as described above preferably may be implemented by groupware (sharing means) in cooperation with an application program executed by another information processing terminal 300 or an information processing apparatus such as a personal computer. In this case, for example, when the user executes the AR data display process from the information processing terminal 300 and acquires information that “all the SD cards have been removed” for the image forming apparatus 100, this information can be shared by other users who use the groupware. The groupware serves as a sharing device. Therefore, not only the confirmed user but also other users can share the information that “all the SD cards have been removed”. Further, a plurality of external devices of identical type may be mounted on the image forming apparatus 100, and the AR mounting status display 319 may distinguishably display the external devices on the display controller 305.

The processes from steps S102 to S106 related to the authentication of the information processing terminal 300 in the AR data display illustrated in FIG. 8 are executed only at the first time and are not necessary performed after the second time. Thus, the processes from steps S102 to S106 can be omitted after receiving the authentication from the model information storing server 200 (for example, after receiving a certificate).

AR Data Display Screen

Next, an example of displaying the AR data on the display controller 305 of the information processing terminal 300 is described. FIG. 9 is a schematic view of an example of the AR data display displayed on the display controller 305 of the information processing terminal 300.

As illustrated in FIG. 9, the display controller 305 of the information processing terminal 300 displays the AR data and the mounting information acquired from the image forming apparatus 100 by superimposing the AR data and the mounting information on the image of the image forming apparatus 100 captured by the image capturing device 307. The AR data relates to the model of the image forming apparatus 100 acquired from the model information storing server 200.

The user during photographing holds the information processing terminal 300 by hand. Thus, the subject (image forming apparatus 100) taken by the user may be blurred. Further, a position of the subject also changes according to a movement of the user such as when the user shoots (images) the image forming apparatus 100 while moving around the periphery of the image forming apparatus 100. Thus, the information display system 1 executes the AR data display process by superimposing and displaying the mounting position and mounting information on the image of the image forming apparatus according to the displacement of the image forming apparatus 100 in the screen of the display controller 305.

For example, when the user continues shooting (imaging) with the image forming apparatus 100 while moving the image forming apparatus 100 around, the AR data displayed on the display controller 305 is also rotated, enlarged, and reduced according to the status of the image forming apparatus 100 to be displayed on the display controller 305 by superimposing the AR data on the image of the image forming apparatus 100.

A known or new AR display technology may be used for the technology for tracking the movement of the user, and the technology for tracking is not particularly limited. Thus, a detailed explanation of the technology for tracking is omitted. In this tracking process, for example, matching between the model information and the AR 3D data is executed. The matching between the model information and the AR 3D data is executed by pasting the AR marker on the image forming apparatus 100 when linking the image data and the AR 3D data and extracting a characteristic point for performing a rotation, enlargement, and reduction of the AR data. Further, the matching between the model information and the AR 3D data may be executed by ensuring that the user temporarily shoots the image from the predetermined position (front) of the image forming apparatus 100 so that the model information coincides with the AR 3D data.

According to the information display system 1 according to the present embodiment described above, the user of the information processing terminal 300 can visually grasp the mounting position of the external device attachably detachable from the image forming apparatus 100 by communicating with the model information storing server 200 disposed remotely from the information processing terminal 300, acquiring the AR data for the image forming apparatus 100, and displaying the AR data by superimposing the AR data on the image captured by the image capturing device 307. Further, the user can acquire the mounting status of the external device from the image forming apparatus 100 and visually grasp the mounting status of the external device.

Therefore, as illustrated in FIG. 9, the information of the external device is displayed visually in augmented reality (AR) on the screen of the information processing terminal 300 such as a smartphone or the like to improve the user's operability. The information of the external device includes the mounting position of the SD card slot 120, the status of installing/uninstalling of the SD card to the SD card slot 120, the status of mounting/unmounting of the SD card to the SD card slot 120, the mounting position of the terminal of each cables to a debug cable inlet 124, the position of each supply and the status of a consumable supplies such as a remaining amount of toner 128, 129, and 130 such as 60% for toner (cyan) 128, 60% for toner (magenta) 129, and 10% for toner (black) 60%, and number of remaining sheets of paper (B5 and A4 in size) in the paper feeding tray 126, for example.

Even if the slot positions of the SD card slot 120 or the USB slot 122 is different for each image forming apparatus 100, the slot position can be easily confirmed by highlighting the slot position with the augmented reality (AR). Further, even when the slot positions are scattered on the image forming apparatus 100, the mounting information of the external device is transmissively displayed on the display controller 305 with the augmented reality (AR) by the image of the image forming apparatus 100 taken by the user by the information processing terminal 300.

The user can obtain necessary information without moving and actually confirming the periphery of the image forming apparatus 100. Further, even when a plurality of image forming apparatuses 100 are arranged, the user can simultaneously acquire the AR data and visually grasp the mounting information of the external device without moving around the plurality of the image forming apparatus 100.

Therefore, for example, the present embodiment can prevent the user from forgetting to remove the external device after the external device is mounted to the image forming apparatus 100 and is used. Further, the present embodiment can immediately find the external device on the image forming apparatus 100 even if other users forget to remove the external device after using the external device. For example, the user can easily check whether the user forgets to remove the external device from the image forming apparatus 100 by habitually imaging the image forming apparatus 100 after use with the camera of the information processing terminal 300.

Further, the user can visually grasp where the user can mount the external device on the image forming apparatus 100. Even a user who has not used the corresponding image forming apparatus 100 before or who is not familiar with the image forming apparatus 100 can quickly mount and dismount the external device to and from an appropriate position of the image forming apparatus 100.

Further, for example, when an instruction to replace a consumable supply item such as toner is displayed on a control panel such as the display controller 305 while using the image forming apparatus 100, the instruction is displayed on the display controller 305 with a simplified diagram. Thus, even when it is difficult for the user to recognize an actual position of the external device or the like, the user can easily and quickly confirm the position of the external device on the image displayed on the display controller 305 by imaging the image forming apparatus 100 with the information processing terminal 300.

The embodiments described above are just preferred embodiments and the present disclosure is not limited thereto. Numerous additional modifications and variations are possible in light of the above teachings. Such modifications and variations are not to be regarded as a departure from the scope of the present disclosure and appended claims, and all such modifications are intended to be included within the scope of the present disclosure and appended claims.

For example, any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information display system comprising:
an image forming apparatus including circuitry to monitor whether an external device is mounted to the image forming apparatus;
a server communicably connected to the image forming apparatus, the server including a memory to store AR data to be displayed in augmented reality corresponding to the image forming apparatus and including at least data indicating a mounting position of the external device to the image forming apparatus; and
an information processing terminal communicably connected to the image forming apparatus and the server, the information processing terminal including circuitry to:
acquire the AR data of the image forming apparatus from the server;
control a display to display the AR data, the AR data being superimposed on the captured image data;
acquire mounting information indicating whether the external device is mounted to the image forming apparatus from the image forming apparatus; and
control the display to display the mounting information, the mounting information being superimposed on the captured image data and the AR data.

2. The information display system according to claim 1, wherein the circuitry of the image forming apparatus further monitors whether the external device is usable when the external device is mounted on the image forming apparatus, and
the mounting information further indicates whether the external device is usable.

3. The information display system according to claim 2, wherein the circuitry of the information processing terminal is further configured to:
transmit, to the image forming apparatus, a request for changing a status of the external device between the usable status and an unusable status, and
the circuitry of the image forming apparatus controls to change the status of the external device according to the request for changing.

4. The information display system according to claim 1, wherein the external device includes a plurality of external devices each mountable to the image forming apparatus, and
the circuitry of the information processing terminal displays the mounting position of each of the plurality of external devices with different color.

5. The information display system according to claim 1, wherein the external device includes a plurality of external devices of identical type each mounted on the image forming apparatus, and
the circuitry of the information processing terminal distinguishably displays the external devices on the display.

6. The information display system according to claim 1, wherein the circuitry of the information processing terminal further requests authentication of an imaging target to the image forming apparatus,
the circuitry of the server further determines whether the information processing terminal is usable in the information display system,
the circuitry of the image forming apparatus further comprises a relay device to relay an authentication between the information processing terminal and the server.

7. The information display system according to claim 1, wherein, when the information processing terminal includes a plurality of information processing terminals, the system further comprising:
a sharing device to share the mounting information acquired by one of the plurality of the information processing terminals with other information processing terminals.

8. The information display system according to claim 1, wherein at least one of paper, toner, and a waste toner collector is exchangeably mountable to the image forming apparatus as the external device.

9. The information display system according to claim 1, wherein the information processing terminal and the image forming apparatus are communicable by short-range wireless communication.

10. An information processing terminal comprising:
an image capturing device to capture an image of an image forming apparatus communicably connected to the information processing terminal;
an image data display to display image data of the image forming apparatus captured by the image capturing device;
an AR data display to acquire AR data of the image forming apparatus from a server communicably connected to the image forming apparatus and the information processing terminal and to display the AR data by superimposing the AR data on the image data displayed on the image data display; and
a mounting status display to acquire mounting information indicating whether an external device is mounted to the image forming apparatus from the image forming apparatus and to display the mounting information by superimposing the mounting information on the image data and the AR data displayed on the image data display.

11. A display method comprising:
displaying image data of an image forming apparatus captured by an image capturing device on a display of an information processing terminal;
acquiring AR data of the image forming apparatus from a server communicably connected to the image forming apparatus and the information processing terminal;
displaying the AR data on the display, the AR data being superimposed on the image data being displayed on the display;
acquiring mounting information indicating whether an external device is mounted to the image forming apparatus from the image forming apparatus; and
displaying the mounting information on the display, the mounting information being superimposed on the image data and the AR data being displayed on the display.
